(19) United States
(12) Patent Application Publication
(10) Pub. No.: US 2026/0049541 A1
(43) Pub. Date: Feb. 19, 2026

(54) SYSTEM AND METHOD FOR CAPTURING AND REPURPOSING GAS RELEASED DURING OILFIELD OPERATIONS

(71) Applicant: CNX Resources Corporation, Canonsburg, PA (US)

(72) Inventors: Cody Lee Craker, Washington, PA (US); Richard Frank Molla, Monaca, PA (US); Joseph Michael Fink, Washington, PA (US)

(21) Appl. No.: 19/301,067

(22) Filed: Aug. 15, 2025

Related U.S. Application Data
(60) Provisional application No. 63/684,293, filed on Aug. 16, 2024.

(51) Int. Cl. E21B 43/12; F17C 1/00

(52) U.S. Cl. CPC E21B 43/122; F17C 1/005; F17C 2203/013; F17C 2221/033; F17C 2250/0426

(57) ABSTRACT

A release gas capture and repurposing system and method designed for use in oilfield operations. The system includes a collection assembly that is attached to oilfield equipment to gather gas released during operation. Once collected, the release gas is channeled to a pressure vessel where the release gas is securely captured. A meter is installed in fluid communication with this vessel, which serves to measure the amount of captured release gas. The system also incorporates a conduit network that prevents the release of gas and condensate vapors to open-top tanks by directing the captured release gas to a designated location. Further, the system includes an emissions calculator that estimates a reduction in greenhouse gas emissions based on a quantity of release gas captured and redirected by the system relative to conventional methods and quantified by the meter.

### CROSS-REFERENCE TO RELATED APPLICATION

This application claims benefit under 35 U.S.C. § 119(e) to U.S. Provisional Application No. 63/684,293, filed Aug. 16, 2024, entitled “SYSTEM AND METHOD FOR CAPTURING AND REPURPOSING GAS RELEASED DURING OILFIELD OPERATIONS,” the entire disclosure of which is herein incorporated by reference.

### TECHNICAL FIELD

This disclosure relates to various oilfield operations which produce natural gas products from underground formations. More particularly, this disclosure relates to environmental management technologies in oilfield operations. More specifically, this disclosure pertains to a system and method for capturing and repurposing gas released during oilfield operations for reducing emissions and reclaiming gases that would otherwise be wasted for environmental and economic benefits.

### BACKGROUND

In the context of oil extraction processes, the unintentional release of hydrocarbon gases, predominantly methane, poses considerable environmental and economic challenges. Methane, a potent greenhouse gas, contributes significantly to climate change when emitted into the atmosphere. The industry is currently grappling with the need for sophisticated systems that can constrain such emissions. These systems should not only prevent environmental degradation but also capitalize on the potential economic value of these emissions by repurposing the captured gases.

During standard oilfield procedures, equipment such as sand traps and manifolds serve as inadvertent sources of methane discharge. Conventional methods employed for managing post-drilling activities, referred to as flowback processes, are major contributors to atmospheric methane concentrations. This escalation of methane levels presents serious environmental considerations and leads to the accrual of financial liabilities in the form of emissions penalties as regulated by environmental governance.

Oilfield operations typically involve practices that result in substantial methane emissions, which, apart from contributing to atmospheric pollution, symbolize the forfeiture of a potential asset. The emissions'impact is quantifiable through metrics indicating carbon dioxide equivalence per well, underlining the profound environmental implications. Considering pressing environmental mandates and cost-efficient operational prerequisites, the industry demands innovative capture systems that effectively minimize emissions while enabling advantageous utilization of these otherwise unexploited hydrocarbons. In a conventional oilfield operation, the loss of methane to atmosphere, including sand trap blow down operations, can be as high as or higher than about 6,000 tons CO₂ per well.

There remains a notable deficiency within the existing art for a system that thoroughly addresses the comprehensive capture and subsequent employment of these hydrocarbon gases. The prior art has yet to provide an end-to-end solution that effectively marries the objectives of mitigating environmental impact with the incentivization of reclaiming and repurposing the captured gases. Such a system represents a necessary advancement within the field, offering the promise of both environmental and economic improvements in oilfield gas management.

### SUMMARY

The present disclosure provides a system and method for capturing and repurposing gases that are typically released during oilfield extraction activities. The system integrates several components which include, but are not limited to, gas collection assemblies, a pressure vessel, a device for metering the captured gases, a fluid conduit system to channel the gases, and an emissions calculator. These components operate cooperatively to capture gas emissions, typically released from oilfield equipment, measure the captured gas, maintain the captured gas at a suitable pressure commensurate, direct the captured gas for either commercial sale or combustion, and estimate a reduction in greenhouse gas emissions as a result of the system.

Specifically, this disclosure provides a system and method primarily purposed to counter the prevalent practice of discharging gases into the atmosphere during oilfield operations, conveying a dual advantage of emission mitigation and the prospect of sanctioning the sale of gas which has traditionally been deemed non-recoverable. The collection assemblies operate to secure methane and other related gas discharges, the pressure vessel stores these gases at appropriate operational pressures, and the metering device precisely archives the volume of gathered gas. Subsequently, the fluid conduit system channels the confined gases towards their envisioned utilities and the emissions calculator gauges a reduction in greenhouse gas emissions based on a quantity of gas captured and transported by the system.

A feature of the system is the twofold benefit it confers—ecologically and economically. By impeding the release of hazardous gases into the air and thwarting the escape of condensate vapors into open reservoirs, the system substantially reduces the volume of methane emissions. This reduction equates to the curtailment of potential liabilities often encountered with standard flowback maneuvers in the oil industry, thereby fostering environmental stewardship while simultaneously encouraging fiscal prudence. Overall, the present disclosure introduces a comprehensive system aimed at improving the environmental footprint of oilfield operations while also providing economic analysis tools for the beneficial use of the otherwise wasted gas.

In a first embodiment, the present disclosure describes a system for capturing and repurposing gas released during oilfield operations. The system includes a collection assembly connected to oilfield equipment to collect release gas, a pressure vessel to receive and capture the release gas from the collection assembly and maintain the release gas under pressure, and a meter in fluid communication with the pressure vessel for quantifying the captured gas. The system further includes a conduit system for preventing the release of gas and condensate vapors to any open-top tanks by directing the captured release gas to a destination and an emissions calculator for estimating a reduction in greenhouse gas emissions based on a quantity of release gas captured and redirected by the system relative to conventional methods and quantified by the meter.

In one aspect of the first embodiment, the pressure vessel is adapted to maintain the release gas captured in the pressure vessel at a pressure suitable for subsequent transport through a pipeline.

In another aspect of the first embodiment, which may be combined with one or more previously recited aspects of the first embodiment, the pressure vessel includes baffles in an interior chamber thereof.

In another aspect of the first embodiment, which may be combined with one or more previously recited aspects of the first embodiment, the meter includes a flow meter to measure a volume of the release gas redirected to the destination in terms of Mcf (thousand cubic feet).

In another aspect of the first embodiment, which may be combined with one or more previously recited aspects of the first embodiment, the system further includes a financial analysis module to calculate an economic value derived from the captured release gas based on market price or a methane penalty cost associated with emissions from conventional oilfield operations processes.

In another aspect of the first embodiment, which may be combined with one or more previously recited aspects of the first embodiment, the system further includes a measurement module to provide the emissions calculator and the financial analysis module with input and gas composition data retrieved from the collection assembly, the pressure vessel, and the meter.

In another aspect of the first embodiment, which may be combined with one or more previously recited aspects of the first embodiment, the emissions calculator generates an inventory statement and the financial analysis module generates a gas volume statement.

In another aspect of the first embodiment, which may be combined with one or more previously recited aspects of the first embodiment, the collection assembly is selected from at least one of a sand trap, a manifold, or a phase separator adapted for use at natural gas wells, or a combination thereof.

In another aspect of the first embodiment, which may be combined with one or more previously recited aspects of the first embodiment, the conduit system directs the captured release gas to a downstream natural gas pipeline.

In another aspect of the first embodiment, which may be combined with one or more previously recited aspects of the first embodiment, the conduit system directs the captured release gas to a combustion device.

In another aspect of the first embodiment, which may be combined with one or more previously recited aspects of the first embodiment, the system is adapted to reduce methane emissions relative to a conventional flowback process, a well drill out operation, a convention well kickoff, or a conventional blowdown process by capturing release gases that would otherwise be vented to the atmosphere.

In a second embodiment, the present disclosure describes a method for capturing and repurposing gas released during oilfield operations. The method includes collecting release gas by a collection assembly connected to oilfield equipment, receiving and capturing the release gas from the collection assembly into a pressure vessel, and maintaining the release gas under pressure in the pressure vessel. The method further includes quantifying the captured release gas by a meter in fluid communication with the pressure vessel, directing the captured release gas to a destination by a conduit system, and estimating by an emissions calculator a reduction in greenhouse gas emissions based on a quantity of the captured release gas directed to the destination relative to conventional methods.

In one aspect of the second embodiment, the method further includes maintaining the captured release gas in the pressure vessel at a pressure suitable for subsequent transport through a pipeline.

In another aspect of the second embodiment, which may be combined with one or more previously recited aspects of the second embodiment, the method further includes measuring a volume of the release gas redirected to the destination in terms of Mcf (thousand cubic feet) by the meter including a flow meter.

In another aspect of the second embodiment, which may be combined with one or more previously recited aspects of the second embodiment, the method further includes calculating by a financial analysis module an economic value derived from the captured release gas based on a market price or a methane penalty cost associated with emissions from conventional flowback process.

In another aspect of the second embodiment, which may be combined with one or more previously recited aspects of the second embodiment, the method further includes generating by the emissions calculator an inventory statement and generating by the financial analysis module a gas volume statement.

In another aspect of the second embodiment, which may be combined with one or more previously recited aspects of the second embodiment, the method further includes collecting the release gas from at least one of a sand trap, a manifold, or a phase separator adapted for use at natural gas wells, or a combination thereof.

In another aspect of the second embodiment, which may be combined with one or more previously recited aspects of the second embodiment, the method further includes directing the captured release gas to a downstream natural gas pipeline by the conduit system.

In another aspect of the second embodiment, which may be combined with one or more previously recited aspects of the second embodiment, the method further includes directing the captured release gas to a combustion device by the conduit system.

In another aspect of the second embodiment, which may be combined with one or more previously recited aspects of the second embodiment, the method further includes reducing methane emissions relative to a conventional flowback process, a well drill out operation, a convention well kickoff, or a conventional blowdown process by capturing release gases that would otherwise be vented to the atmosphere.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 depicts a system for capturing and repurposing gases that are typically released during oilfield extraction activities, according to at least one aspect of this disclosure.

FIG. 2 depicts a system for capturing and repurposing gases that are typically released during oilfield extraction activities, according to at least one aspect of this disclosure.

FIG. 3 is a logic flow diagram depicting a method for capturing and repurposing gases that are typically released during oilfield extraction activities, according to at least one aspect of this disclosure.

FIG. 4 is a schematic diagram of a system for capturing and repurposing gases that are typically released during oilfield extraction activities including an emission calculator and a financial analysis module, according to at least one aspect of this disclosure.

FIGS. 5A-5F depict a potential emissions inventory statement produced by an emissions calculator for gauging the reduction of greenhouse gas emissions, according to at least one aspect of this disclosure.

FIGS. 6A-6B depict a gas volume statement produced by a financial analysis module to estimate the economic value of the captured release gas, considering market prices or saved methane emission penalties based on data received from the meter, according to at least one aspect of this disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

In the following description, it is to be understood that such terms as “forward,” “rearward,” “left,” “right,” “above,” “below,” “upward,” “downward,” and the like are words of convenience and are not to be construed as limiting terms.

This disclosure proposes a system and method that responds to increasing environmental concerns and the necessity for careful energy resource management within oilfield operations. The system and method adeptly capture, gauge, pressurize, and repurpose gas emissions, particularly from flowback processes. Operation of the system and method disclosed herein is attuned to contemporary global mandates for sustainability and efficient resource use.

At their core, the system and method are concerned with environmental governance in oilfield practices, aiming to diminish emissions and the consequent economic penalties from gas release, mainly methane. The integrated approach of the disclosed system for gas capture and repurposing is a formidable stride in lowering the environmental impact of oil extraction activities while simultaneously augmenting economic gains.

The system and method achieve a significant reduction in environmental and fiscal detriments by capturing and recycling gases during oilfield processes. The present disclosure integrates progressive methodologies in gas collection, quantification, and management, thus curtailing methane emissions and offering a utilitarian alternative for these emissions. The system and method ensure the economic valorization of gases that otherwise might be disregarded, presenting both ecological and economic benefits.

The operational essence of the system lies in its capacity to capture gas at its emission point and subsequently convey it through a measured and safe path, culminating in its predestined application. By doing so, the system not only alleviates the discharge of greenhouse gases but also carves a pathway for the conversion of what was previously considered waste into a tangible asset, marking a significant innovation in the field of oil and gas production.

In various embodiments, the system includes collection assemblies for gas capture, a pressure vessel for storage, a metering device for volume quantification, and a conduit system for directing the gas to its intended use. The configuration of the system prevents emissions to open-top tanks and allows for comprehensive emissions management and financial optimization.

The system operates by collection assemblies capturing gas at the point of release during oilfield operations and directing the captured gas to the pressure vessel. The gas volume is measured by the metering device, ensuring accurate quantification for commercial transactions or environmental reporting. The pressure vessel maintains the gas at a predefined pressure suitable for transportation or utilization, while the conduit system ensures the safe and directed flow of the gas to the intended destination. This operation not only reduces methane emissions but also provides a mechanism for reaping economic benefits from what would be otherwise wasted resources. The entire system is configured to eliminate the need for open-top tanks where gas and condensate vapors might be released, ensuring a closed system that significantly cuts emissions. For example, in one implementation, the gases can be stored in the pressure vessel and flared for a total of about 20 tons CO₂. In terms of financial benefits, with no methane penalty, based on the U.S. methane penalty value of methane, the system can add, for example, about $48K/well, or more, of methane penalty cost to each well as compared to conventional flowback operations. In other embodiments, the system includes emissions reduction and financial analysis tools to determine actual methane penalties, overall cost savings, and the value of gas sold in downstream pipelines.

In one embodiment, the system may include collection assemblies, a pressure vessel in fluid communication with the collections assemblies. A metering device may be placed in fluid communication with the pressure vessel. A conduit system to direct the gas to the pressure vessel.

The collection assemblies are configured to capture gas released from oilfield equipment. The collection assemblies may be strategically connected to oilfield equipment and are responsible for capturing the gas that is typically released into the atmosphere during oilfield operations. The collection assemblies may include sand traps, manifolds, or phase separators, or combinations of these components. In one or more embodiments, the collection assemblies may include a phase separator operable to separate fluid, sand, and debris from a stream of captured gas at pressures available at a wellbore, prior to gas pressure reduction. The phase separator may be a phase separator as described in commonly owned U.S. Patent Application Publication No. 2022/0154568. The teachings of U.S. Patent Application Publication No. 2022/0154568 are incorporated herein by reference.

The captured gas is channeled into the pressure vessel, which is designed to maintain the gas at a predefined pressure range, making it suitable for sale or efficient combustion. The pressure vessel receives the captured gas from the collection assemblies, maintaining the gas at a pressure conducive to either transportation through a sales pipeline or delivery to a combustion device.

The metering device placed in fluid communication with the pressure vessel, quantifies the captured gas volume. The metering device placed in fluid communication with the pressure vessel measures the volume of gas in thousand cubic feet (Mcf) that is redirected towards the end destination.

The conduit system directs the pressure, measured gas to a chosen destination such as a sales pipeline or combustion device, ensuring no release into open-top tanks. The conduit system ensures the safe transportation of the pressure and measured gas to either a sales pipeline for economic gains or to a combustion device, aligning with environmental safety measures.

Further, the system includes an emissions calculator to estimate the reduction in greenhouse gas emissions achieved through the capture and repurposing of the gas in comparison to conventional flowback processes. The emissions calculator within the system allows for the estimation and comparison of greenhouse gas emissions with conventional methods.

In another embodiment, the system may include a financial analysis module to analyze the economic impact by calculating the financial value of the captured gas, considering market prices or methane penalty costs typically associated with emissions from conventional methods. The financial analysis module calculates the economic value derived from the captured gas considering market prices or the cost associated with methane penalties.

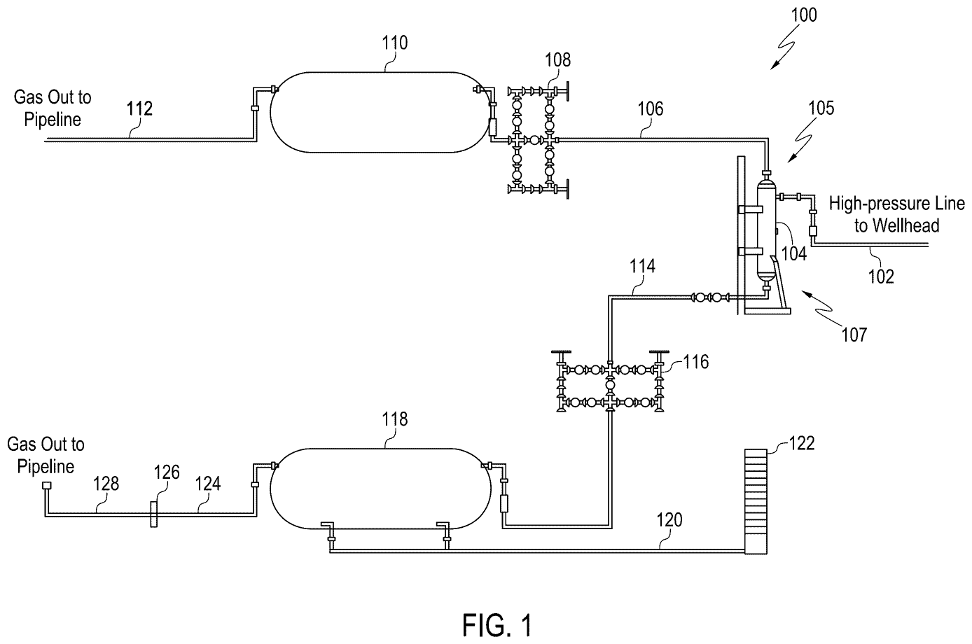

Turning now to the figures, FIG. 1 depicts a system 100 for capturing and repurposing gases that are typically released during oilfield extraction activities, according to at least one aspect of this disclosure. Release gas is piped from the wellhead to a collection assembly such as a sand trap 104 through a high-pressure line 102 in fluid communication with the wellhead. In one implementation, the pressure in the high-pressure line 102 is about 9,000 psig. In one embodiment, the collection assembly may include the sand trap 104, manifolds 108, 116, or phase separators, or combinations thereof.

Fluid exits the sand trap 104 at one end 105 through pipe 106 and is fluidically coupled to a first pressure vessel 110 through a first manifold 108. The pressure vessel 110 is configured to receive gases from the collection assembly. In one embodiment, the first pressure vessel 110 may be a high-pressure stage separator (e.g., rated for about 1,440 psig). The first pressure vessel 110 may include one or more baffles to further separate gas from the constituent fluid (e.g., water and other debris) received from the sand trap 104. Release gas exits the pressure vessel 110 and is fluidically coupled by a pipe 112 into a natural gas pipeline.

The sand trap 104, also known as sand separators, well traps, or oilfield traps, separate sand and other small particles from water. When well sand traps pull water up, the solid material will drop into a vessel where the parts will move around and separate the sand and other solids from the liquid. Pulling the liquid up and dropping it into a vessel is the first barrier to removing solid matter from the water before different filters complete the final stage of cleaning. Sand separators help reduce the time and energy spent trying to separate the solids from the liquids. This helps streamline the process and supports the effort required to keep up with downstream machines. Heavier substances (e.g., sands and solids) accumulate on the bottom of the vessel because of gravitational force and are subsequently drained or taken away from the sand trap by a special blowdown system.

Fluid (e.g., gas, water, and other debris) that exits the other end 107 of the sand trap 104 is fluidically coupled to a second pressure vessel 118 through a second manifold 116. In the illustrated embodiment, the second pressure vessel 118 may be a high-pressure stage separator (e.g., rated for about 1,440 psig) including a pressure vessel, or tank, and one or more baffles. Water separated from the fluid received by the second pressure vessel 118 is dumped via a water dump line 120, which is fluidically coupled to a gas buster 122. The gas buster 122 is a type of tank used often in drilling projects or oilfield applications. A tank type gas buster is designed to safely allow gases to escape while liquids and sediments are extracted. The gas buster 122 is a simple separator vessel used to remove free or entrained gas from fluids circulated in the wellbore, such as mud used during drilling operations. The gas buster 122 typically includes a vessel containing a series of baffles with a liquid exit on the bottom and a gas-vent line at the top of the vessel. Conventionally, the sand trap 104 is emptied directly into the gas buster 122 and the gas that separated from the water is exhausted directly into the atmosphere.

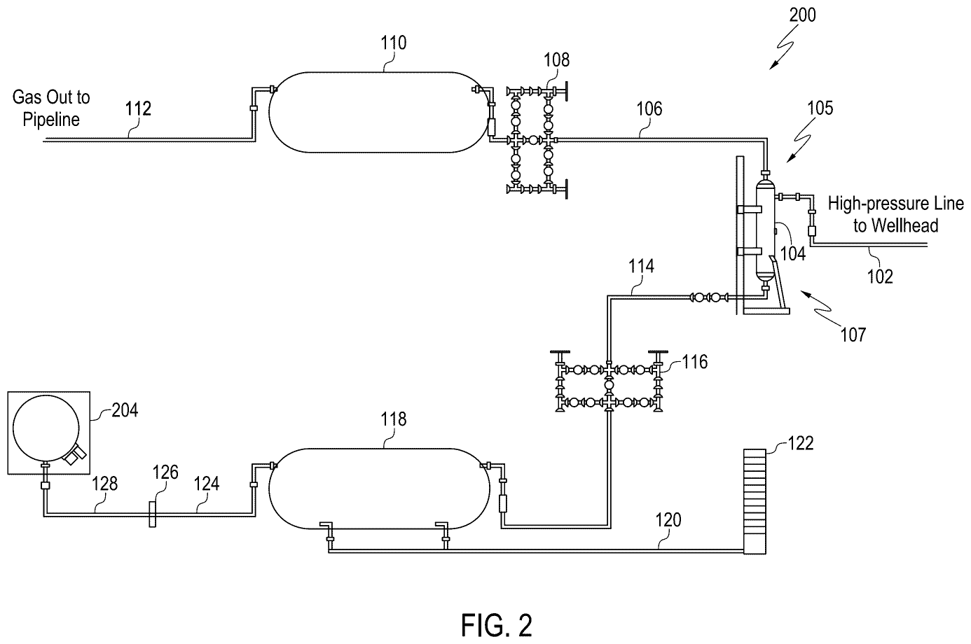

In contrast, according to the embodiment illustrated in FIG. 1, fluid that exits the other end 107 of the sand trap 104 is captured by the second pressure vessel 118 and repurposed. In the illustrated embodiment, captured release gas is repurposed by providing the release gas into a downstream natural gas pipeline. To measure the amount of captured release gas provided into the natural gas pipeline, the output of the second pressure vessel 118 is fluidically coupled to a gas meter 126 through a pipe 124. From the gas meter 126, the release gas is provided into the natural gas pipeline through a pipe 128 at a downstream pressure less than or equal to about 1,000 psig. In the illustrated embodiment, the gas meter 126 is an orifice plate type meter with a 2.75″ orifice configured to measures the volume of release gas provided into the natural gas pipeline. As described in FIG. 2, the captured gas may be repurposed by venting into a flare stack.

FIG. 2 depicts a system 200 for capturing and repurposing gases that are typically released during oilfield extraction activities, according to at least one aspect of this disclosure. In the embodiment depicted in FIG. 2, fluid that exits the other end 107 of the sand trap 104 is captured in a low-pressure vessel 202 and repurposed. The low-pressure vessel 202 may be a 125 psig ASME (American Society of Mechanical Engineers) storage tank/300 bbls (barrels of crude oil) low-pressure stage separator. In the illustrated embodiment, the captured release gas is repurposed by burning through a combustion device 204, such as a flare stack/VDU. To measure the amount of captured gas being flared, the output of the pressure vessel 202 is fluidically coupled to a gas meter 126 through a pipe 124. From the gas meter 126, the release gas is provided to the combustion device 204 through a pipe 128. In the illustrated embodiment, the gas meter 126 is an orifice plate type meter with a 2.75″ orifice configured to measure the volume of captured gas provided to the combustion device 204 to be flared. The combustion device 204 produces a fire as part of controlled burning to stabilize pressure and flow from a well, manage waste gas that cannot be captured or processed, or for safety or emergency situations to release pressure.

A conduit system of pipes 102, 106, 114 and manifolds 108, 116 direct release gas into the pressure vessels 110, 118, 202. Another conduit system of pipes 124, 128 direct the captured release gas to a destination selected from at least one of a natural gas pipeline (e.g., a sales pipeline) or a combustion device 204 (e.g., flare stack/VDU).

In various embodiments, the systems 100, 200 described above are adapted to reduce methane emissions relative to a conventional flowback process by capturing release gases that would otherwise be vented to the atmosphere. Flowback is the first stage of a hydrocarbon well's producing life. Before flowback begins, the well is drilled and then it is faced. A flowback phase may last anywhere from 1-3 months and is essential for optimizing production. The first fluid that is produced from the well is a mix of crude oil, formation water, natural gas, frac sand, as well as frac water and chemicals. It is important to use sand separation technology during flowback to efficiently capture the sand so that sand does not reach the production facility. If a significant amount of sand passes the sand separating equipment in flowback, there will likely be hundreds of thousands of dollars in damage, replacement parts, and clean-up fees. Under conventional operations, gas produced during the flowback phase is either exhausted directly into the atmosphere or combusted through a flare stack. In accordance with the present disclosure, however, gas produced during the flowback phase is captured and repurposed by the systems 100, 200 described in FIGS. 1 and 2.

Additionally, the systems 100, 200 are adapted to reduce methane emissions relative to a conventional well drill out operation. During a drill out operation the fluid, mostly water, is pulled from a frac tank, passed through a blender that can be used to add in chemicals, and is then pumped through the coil/stick pipe down through the milling bottom hole assembly (BHA), and is then circulated out. Under conventional operations, gas produced during a drill out operation is either exhausted directly into the atmosphere or combusted through a flare stack. In accordance with the present disclosure, however, gas produced during a drill out operation is captured and repurposed by the systems 100, 200 described in FIGS. 1 and 2.

Additionally, the systems 100, 200 are adapted to reduce methane emissions relative to a convention well kickoff-an early warning sign to a blowout in oil and gas extraction operations. Unpredictable and extreme pressures beneath the surface can lead to formation fluids to start to flow back up the wellbore. Well kickoffs can be diagnosed by a sudden change in drilling rate, pressure fluctuations, or gases trapped in the mudlogging unit. Usually behaving like a violent hiccup, well kickoffs are early warning signs to more serious and dangerous problems occurring during extraction. Under conventional operations, gas produced during well kickoff is either exhausted directly into the atmosphere or combusted through a flare stack. In accordance with the present disclosure, however, gas produced during a well kickoff is captured and repurposed by the systems 100, 200 described in FIGS. 1 and 2.

Additionally, the systems 100, 200 are adapted to reduce methane emissions relative to a conventional blowdown process. A blowdown process is the purposeful venting of natural gas to the atmosphere during well operations and/or during pipeline operations or maintenance to relieve pressure in the pipe. Under conventional operations, gas produced during a well blowdown process, which can occur as frequently as every two hours, is either exhausted directly into the atmosphere or combusted through a flare stack. In accordance with the present disclosure, however, gas produced during a blowdown process is captured and repurposed by the systems 100, 200 described in FIGS. 1 and 2.

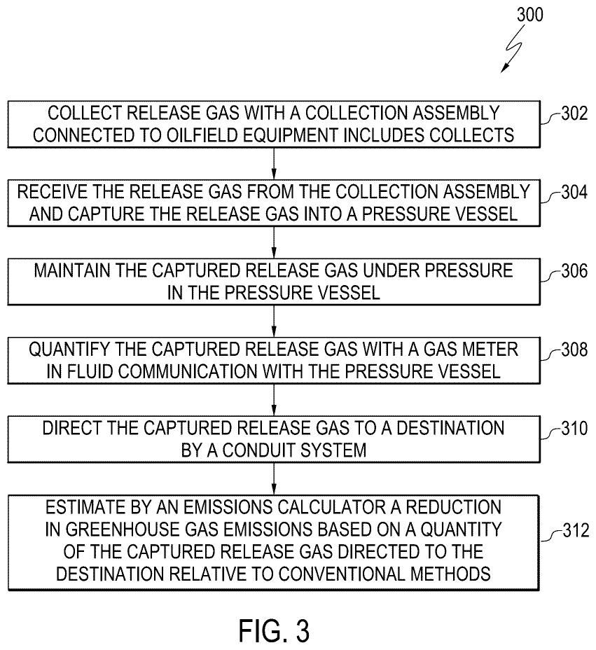

FIG. 3 is a logic flow diagram depicting a method 300 for capturing and repurposing gases that are typically released during oilfield extraction activities, according to at least one aspect of this disclosure. According to the method 300, a collection assembly connected to oilfield equipment includes collecting 302 release gas. The release gas collected by the collection assembly is received and captured 304 into a pressure vessel. The captured release gas is maintained 306 under pressure in the pressure vessel. The captured release gas is quantified 308 by a meter in fluid communication with the pressure vessel. The captured release gas is directed 310 to a destination by a conduit system. A reduction in greenhouse gas emissions is estimated 312 relative to conventional methods by an emissions calculator based on a quantity of the captured release gas directed to the destination.

According to the method 300, the captured release gas may be maintained in the pressure vessel at a pressure suitable for subsequent transport through a pipeline.

According to the method 300, a volume of the gas may be redirected to the destination in terms of Mcf (thousand cubic feet) is measured by the meter comprising a flow meter.

According to the method 300, a financial analysis module may calculate an economic value derived from the captured gas based on a market price or a methane penalty cost associated with emissions from conventional flowback process.

According to the method 300, the emissions calculator may generate an inventory statement and the financial analysis module may generate a gas volume statement.

According to the method 300, at least one of a sand trap, a manifold, or a phase separator adapted for use at natural gas wells, or a combination thereof may collect the release gas.

According to the method 300, the captured release gas is directed to a downstream natural gas pipeline.

According to the method 300, the captured release gas is directed to a combustion device.

According to the method 300, methane emissions relative to a conventional flowback process, a well drill out operation, a convention well kickoff, or a conventional blowdown process are reduced by capturing the release gases that would otherwise be vented to the atmosphere.

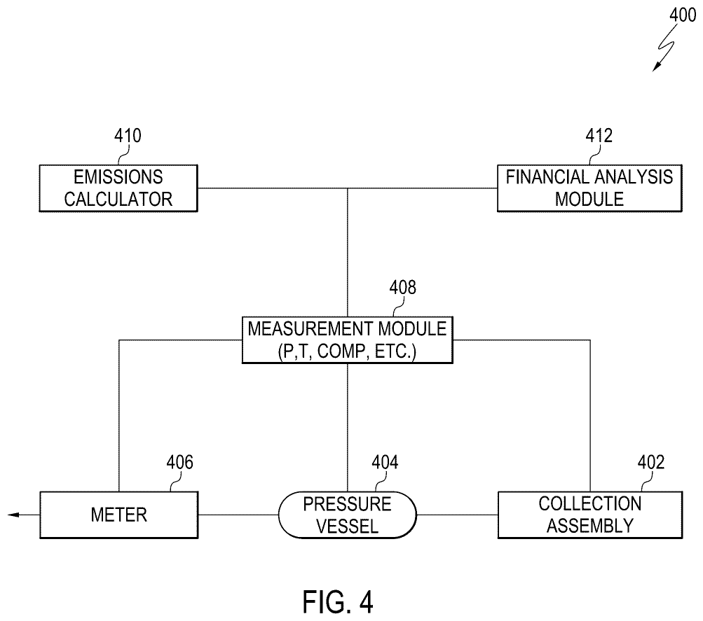

FIG. 4 is a schematic diagram of a system 400 for capturing and repurposing gases that are typically released during oilfield extraction activities including an emission calculator and financial analysis module, according to at least one aspect of this disclosure. A collection assembly 402 gathers release gas. A pressure vessel 404 receives the release gas from the collection assembly 402 and maintains the gas under pressure in a range between about 125 psig and about 3,000 psig, for example. The release gas captured in the pressure vessel 404 is measured by a gas meter 406 before it is released into a destination such as a natural gas pipeline or a flare stack.

A measurement module 408 receives input and gas composition data from the collection assembly 402, the pressure vessel 404, and the gas meter 406. The parameters include, for example, Number of Sand Traps, Description, Chamber (pressure vessel) Diameter (ft), Chamber Volume (ft³), Chamber Pressure (psig), Chamber Pressure (psia), Volume of Pressurized Gas (ft³), Temperature of Chamber (F), Temperature of Chamber (R), Molecular Weight of Gas (lb/lb-mol), Compressibility Factor, Pressurized Density (lb/ft³), Atmospheric Density (lb/ft³), Delta Density (lb/ft³), Mass Emitted (lb/event), Number of Hourly Events, Daily Operation Hours, Gas Composition VOC (% by weight), Gas Composition n-Hexane (% by weight), Gas Composition 2,2,4-TMP (% by weight), Gas Composition Benzene (% by weight), Gas Composition Toluene (% by weight), Gas Composition Ethylbenzene (% by weight), Gas Composition Xylene (% by weight), Gas Composition CO₂ (% by weight), Gas Composition CH₄ (% by weight), among others, for example.

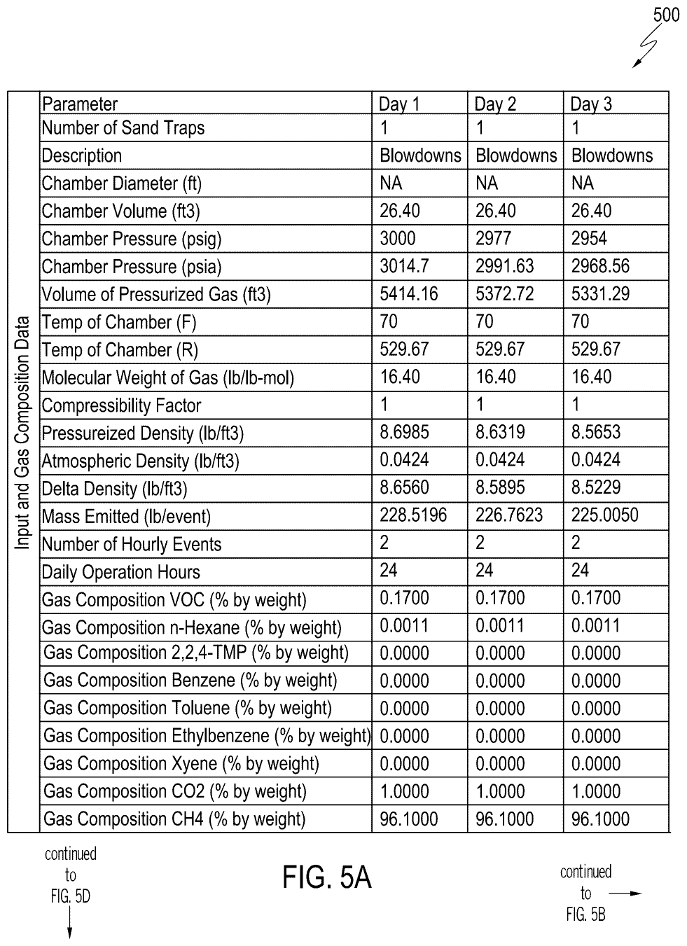

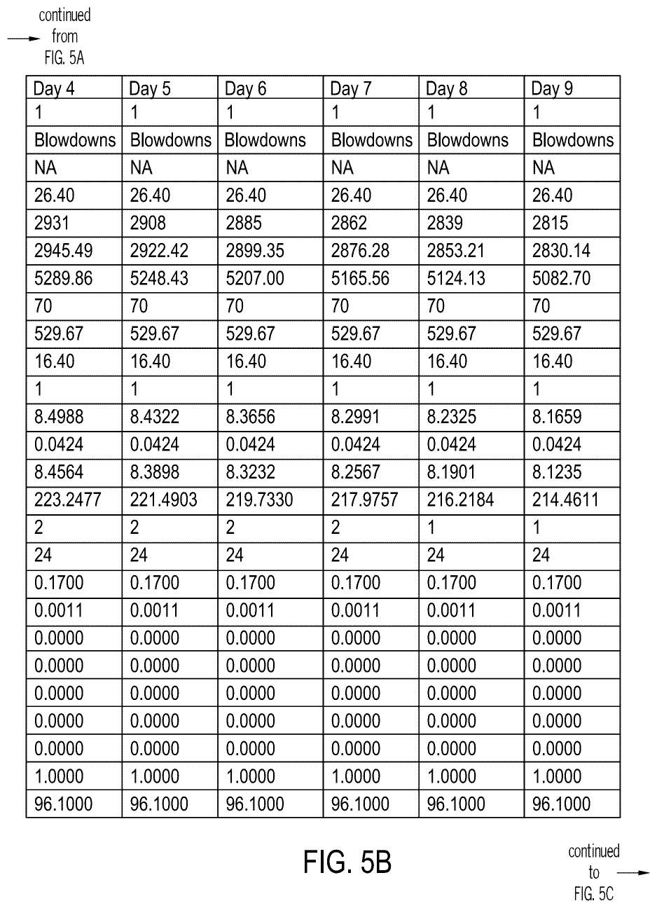

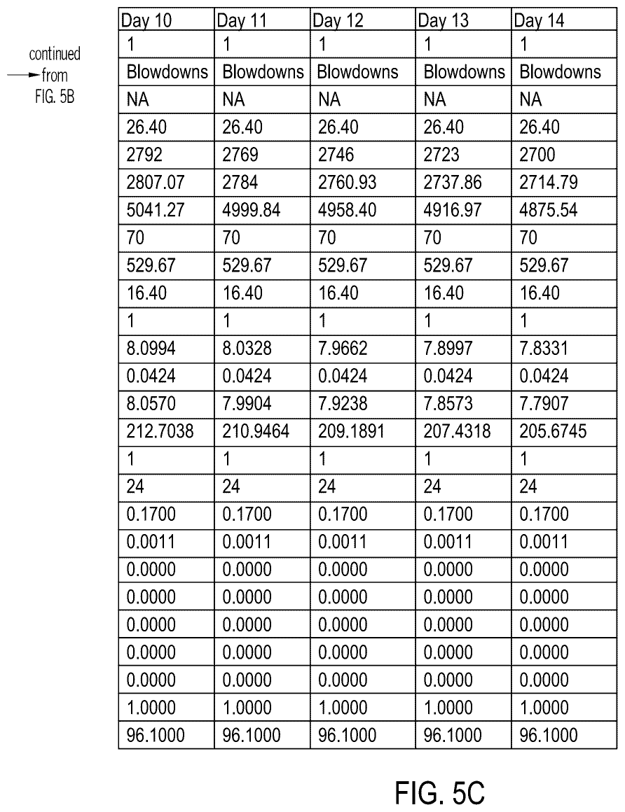

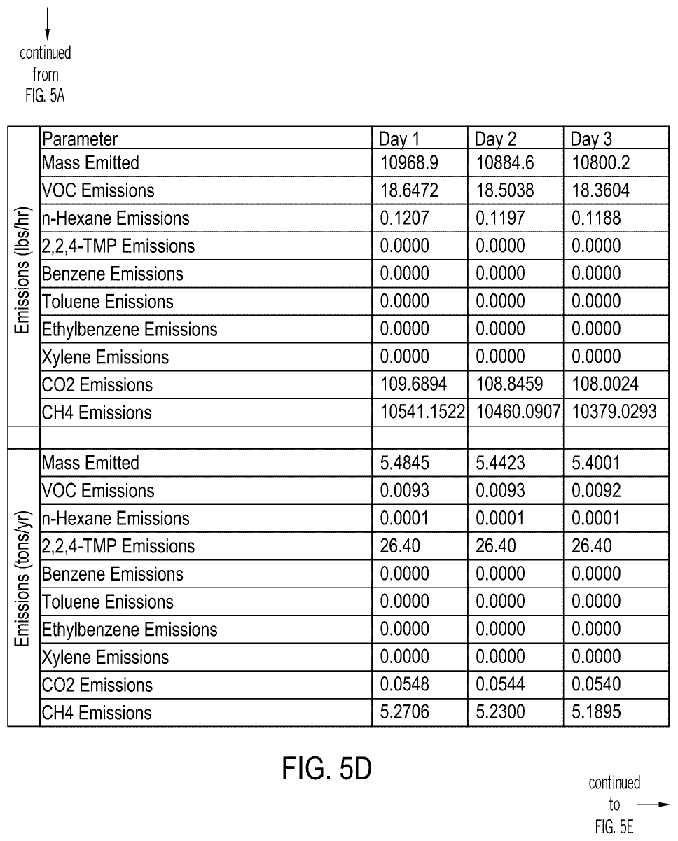

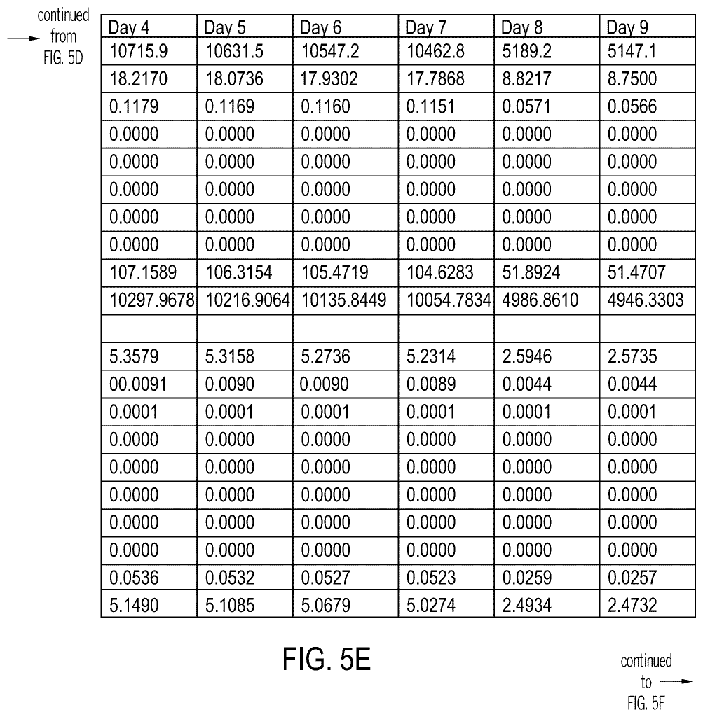

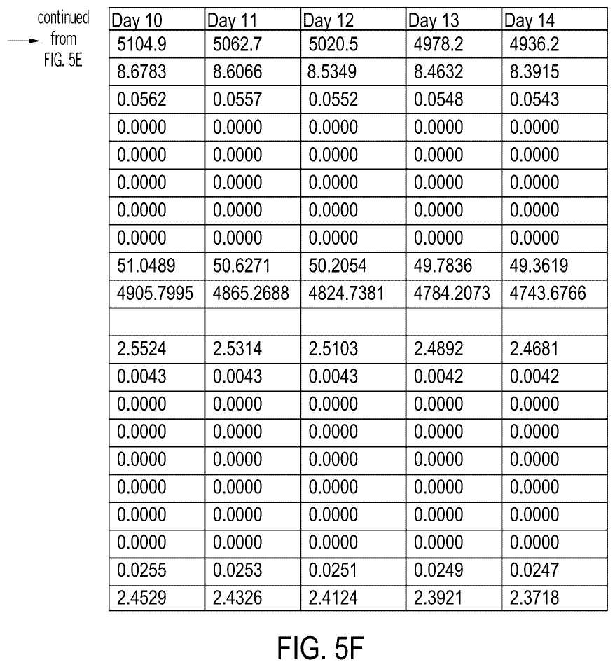

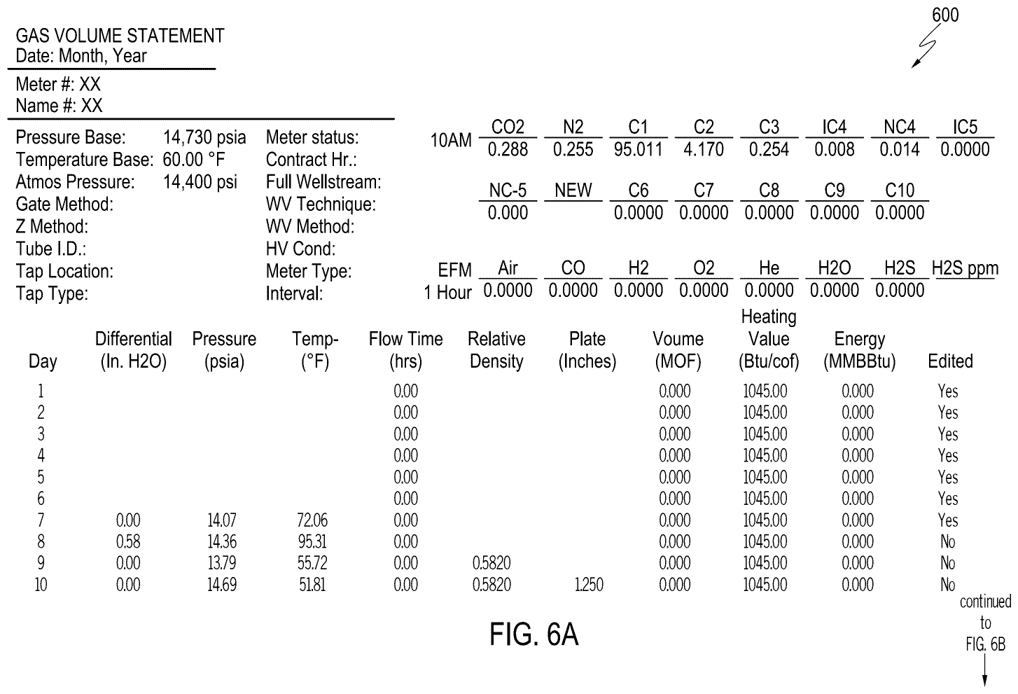

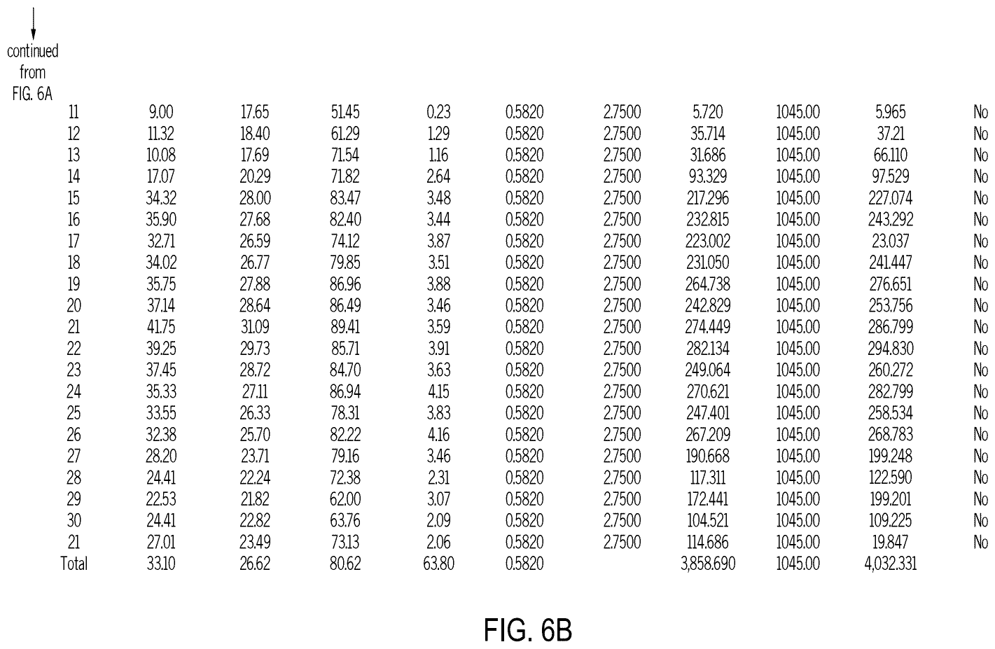

The measurement module 408 provides the above parameters to an emissions calculator 410 and a financial analysis module 412. The emissions calculator 410 generates an inventory statement as shown in FIGS. 5A-5F and the financial analysis module 412 generates a gas volume statement to estimate the economic value of the captured release gas as shown in FIGS. 6A-6B. The emissions calculator 410 determines emissions in pounds per hour (lbs/hr) and tons per year (tons/yr). Emissions (lbs/hr) and emissions (tons/yr) include Mass Emitted, VOC Emissions, n-Hexane Emissions, 2,2,4-TMP Emissions, Benzene Emissions, Toluene Emissions, Ethylbenzene Emissions, Xylene Emissions, CO₂ Emissions, CH₄ Emissions.

FIGS. 5A-5F depict a potential emissions inventory statement 500 produced by an emissions calculator 410 shown in FIG. 4 for gauging the reduction of greenhouse gas emissions, according to at least one aspect of this disclosure.

FIGS. 6A-6B depict a gas volume statement 600 produced by a financial analysis module 412 shown in FIG. 4 to estimate the economic value of the captured release gas, considering market prices or saved methane emission penalties based on data received from the meter, according to at least one aspect of this disclosure.

While various embodiments of a system and method for capturing and repurposing gases that are typically released during oilfield extraction activities were provided in the foregoing description, those skilled in the art may make modifications and alterations to these aspects without departing from the scope of the claimed subject matter. For example, it is to be understood that this disclosure contemplates that, to the extent possible, one or more features of any aspect can be combined with one or more features of any other aspect. As another non-limiting specific example, because natural gas is often odorless, as those of ordinary skill in the art will appreciate it is customary to add an odorant, such as ethyl mercaptan, so that a gas leak can be detected anywhere the gas is being processed or consumed. Therefore, such an odorant can be added to any of the gas products produced in accordance with the present invention. Accordingly, the foregoing description is intended to be illustrative rather than restrictive. The invention described hereinabove is defined by the appended claims, and all changes to the invention that fall within the meaning and the range of equivalency of the claims are to be embraced within their scope.

One or more components may be referred to herein as “configured to,” “configurable to,”“operable/operative to,”“adapted/adaptable,”“able to,”“conformable/conformed to,”etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”and “one or more”to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc. ” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B. ”

Directional phrases used herein, such as, for example and without limitation, top, bottom, left, right, lower, upper, front, back, above, under, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 20%, 15%, 10%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A system for capturing and repurposing gas released during oilfield operations, the system comprising:
a collection assembly connected to oilfield equipment to collect release gas;
a pressure vessel configured to receive and capture the release gas from the collection assembly and maintain the release gas under pressure;
a meter in fluid communication with the pressure vessel for quantifying the captured gas;
a conduit system for preventing the release of gas and condensate vapors to any open-top tanks by directing the captured release gas to a destination; and
an emissions calculator for estimating a reduction in greenhouse gas emissions based on a quantity of release gas captured and redirected by the system relative to conventional methods and quantified by the meter.

2. The system of claim 1, wherein the pressure vessel is adapted to maintain the release gas captured in the pressure vessel at a pressure suitable for subsequent transport through a pipeline.

3. The system of claim 1, wherein the pressure vessel comprises baffles in an interior chamber thereof.

4. The system of claim 1, wherein the meter comprises a flow meter configured to measure a volume of the release gas redirected to the destination in terms of Mcf (thousand cubic feet).

5. The system of claim 1, further comprising a financial analysis module configured to calculate an economic value derived from the captured release gas based on market price or a methane penalty cost associated with emissions from conventional oilfield operations processes.

6. The system of claim 5, further comprising a measurement module configured to provide the emissions calculator and the financial analysis module with input and gas composition data retrieved from the collection assembly, the pressure vessel, and the meter.

7. The system of claim 5, wherein the emissions calculator generates an inventory statement and the financial analysis module generates a gas volume statement.

8. The system of claim 1, wherein the collection assembly is selected from at least one of a sand trap, a manifold, or a phase separator adapted for use at natural gas wells, or a combination thereof.

9. The system of claim 1, wherein the conduit system directs the captured release gas to a downstream natural gas pipeline.

10. The system of claim 1, wherein the conduit system directs the captured release gas to a combustion device.

11. The system of claim 1, wherein the system is adapted to reduce methane emissions relative to a conventional flowback process, a well drill out operation, a convention well kickoff, or a conventional blowdown process by capturing release gases that would otherwise be vented to the atmosphere.

12. A method for capturing and repurposing gas released during oilfield operations, the method comprising:
collecting release gas by a collection assembly connected to oilfield equipment;
receiving and capturing the release gas from the collection assembly into a pressure vessel;
maintaining the release gas under pressure in the pressure vessel;
quantifying the captured release gas by a meter in fluid communication with the pressure vessel;
directing the captured release gas to a destination by a conduit system; and
estimating by an emissions calculator a reduction in greenhouse gas emissions based on a quantity of the captured release gas directed to the destination relative to conventional methods.

13. The method of claim 12, comprising maintaining the captured release gas in the pressure vessel at a pressure suitable for subsequent transport through a pipeline.

14. The method of claim 12, comprising measuring a volume of the release gas redirected to the destination in terms of Mcf (thousand cubic feet) by the meter comprising a flow meter.

15. The method of claim 12, comprising calculating by a financial analysis module an economic value derived from the captured release gas based on a market price or a methane penalty cost associated with emissions from conventional flowback process.

16. The method of claim 15, comprising generating by the emissions calculator an inventory statement and generating by the financial analysis module a gas volume statement.

17. The method of claim 12, comprising collecting the release gas from at least one of a sand trap, a manifold, or a phase separator adapted for use at natural gas wells, or a combination thereof.

18. The method of claim 12, comprising directing the captured release gas to a downstream natural gas pipeline by the conduit system.

19. The method of claim 12, comprising directing the captured release gas to a combustion device by the conduit system.

20. The method of claim 12, comprising reducing methane emissions relative to a conventional flowback process, a well drill out operation, a convention well kickoff, or a conventional blowdown process by capturing release gases that would otherwise be vented to the atmosphere.
